(19) United States
(12) Patent Application Publication
(10) Pub. No.: US 2026/0115813 A1
(43) Pub. Date: Apr. 30, 2026

(54) CUTTING APPARATUSES AND CUTTING INSERTS WITH CHIP BREAKING

(71) Applicant: Kennametal Inc., Latrobe, PA (US)

(72) Inventors: Satish P. Chinnakar, Latrobe, PA (US); Igor Kaufmann, Latrobe, PA (US); Sathish Kumar Nagarajan, Latrobe, PA (US)

(73) Assignee: Kennametal Inc., Latrobe, PA (US)

(21) Appl. No.: 18/928,262

(22) Filed: Oct. 28, 2024

(51) Int. Cl. B23C 5/00; B23C 5/16

(52) U.S. Cl. CPC B23C 5/006; B23C 5/165; B23C 2200/0455; B23C 2200/081

(57) ABSTRACT

A cutting apparatus can include a cutting insert having at least one chip breaking mechanism. A chip breaking mechanism can include an elliptical hump supported by an inner rib. The elliptical hump can be positioned adjacent a corner of a cutting insert body, for example. The elliptical hump can also be positioned adjacent a tapered cutting edge and a plurality of grooves that include an outer groove and an inner groove that have different radiuses are spaced apart from each other by a lip, or step. Embodiments may also include a variable land positioned adjacent to an outwardly from the outer groove to facilitate chip breaking.

### FIELD OF THE INVENTION

The present invention relates to cutting tools (e.g. computer numerical control (CNC) machines, mills, etc.) and cutting inserts for cutting tools (e.g. machining chip breakers for turning, etc.).

### BACKGROUND OF THE INVENTION

Examples of cutting tools can be found in U.S. Pat. Nos. 11,839,920, 11,529,687, 11,090,736, 10,710,167, 10,576,552, 10,166,606, 10,076,788, 9,937,567, 8,840,347, 8,807,888, 8,764,354, 8,702,354, 8,616,810, 8,092,126, 7,625,161, 7,467,915, and 7,407,350 as well as U.S. Patent Application Publication Nos. 2024/0278332, 2024/0198433, 2024/0024958, 2022/0347762, 2022/0339710, 2022/0097145, 2021/0402488, 2019/0039152, 2019/0184468, 2019/0061012, 2016/0082518, 2015/0375303, 2015/0078844, 2013/0272808, 2013/0064613, 2009/0226269, and 2008/0193231. Cutting tools can be used in metalworking, for example. Some cutting tools can be stationary. Other types of cutting tools can be moveable (e.g. rotatable, etc.). A cutting tool can be utilized to manipulate a workpiece to remove material from the workpiece to shape the workpiece and/or define one or more apertures in the workpiece. tairn

### SUMMARY OF THE INVENTION

We determined that some cutting tools can often fail to sufficiently break chips during cutting operations. In some situations, a depth of cut and feed rate can need to be specifically tailored to a particular cutting tool, for example. The inability to sufficiently tailor chip breaking can result in degraded performance or poor work quality. For instance, insufficient chip breaking can result in poor surface finish, higher temperatures at the cutting edge (which can result in the cutting insert experiencing significant wear and other increased maintenance work), and a longer downtime for chip removal during operations.

We have developed cutting tools and cutting tool inserts that can provide enhanced chip breaking functionality that can permit embodiments to be more effectively utilized along a wider range of feed rates, depths of cut, and other operational parameters. Embodiments of the cutting insert can be considered a chip breaker or can include at least one chip breaking mechanism.

For example, embodiments can utilize at least one chip breaking mechanism that can include an elliptical hump supported by an inner rib. The elliptical hump can be positioned adjacent a corner of a cutting insert body. The elliptical hump can also be positioned adjacent a tapered cutting edge and a plurality of grooves that include an outer groove and an inner groove that have different radiuses are spaced apart from each other by a lip, or step. Embodiments may also include a variable land positioned adjacent to and outwardly from the outer groove to facilitate chip breaking and add strength to the cutting edge while also reducing the cutting force of the cutting edge.

Embodiments can be sized and configured so a first face of the body (e.g. a top of the body) of the cutting insert has one or more of the chip breaking mechanisms (e.g. hump, rib, inner and outer grooves, variable land, etc.) adjacent each side and/or corner of the first face of the body. Embodiments an also be sized and configured so a second face (e.g. a bottom that is opposite the top) of the cutting insert has one or more of the chip breaking mechanisms (e.g. hump, rib, inner and outer grooves, variable land, etc.) adjacent each side and/or corner of the second face of the body.

Embodiments can provide a more versatile cutting tool that can facilitate cutting in different turning operations for a large array of materials, feed rates, and depths of cut. Embodiments of the cutting insert can be formed as an integral body that includes one or more of the hump, supporting inner rib, inner and outer grooves, and/or the variable land elements.

Embodiments can also include other features or elements. Embodiments of the cutting insert can have any of a number of different geometric shapes. for example, the body of the cutting insert can be triangular in shape, rectangular in shape, rhombus-like in shape, pentagonal in shape, or have another suitable type of shape. Embodiments of the cutting insert can have a body formed from steel, a ceramic material, a metal, a carbide material, tungsten carbide, or other suitable type of material.

In a first aspect, a cutting insert for a cutting apparatus is provided. The cutting insert can include a body having a top and a bottom. The body can also have a plurality of sides and a plurality of corners. Each of the sides can extend from the top to the bottom and each of the corners can extend from the top to the bottom. The sides can include a first side, a second side, and a third side and the corners can include a first corner, a second corner, and a third corner, the first corner can be between the first side and the second side, the second corner can be between the second side and the third side, and the third corner can be adjacent the third side.

The top of the body can have a hump positioned adjacent the first corner and a rib positioned adjacent the first corner such that the hump positioned adjacent the first corner is positioned between an outer edge of the first corner and the rib positioned adjacent the first corner.

In some embodiments, the top of the body can have additional humps and ribs. In other embodiments, the top of the body and the bottom of the body can each include at least one hump and rib.

In some embodiments, each hump can be elliptical in shape. For example, in some embodiments, the diameter or width of each hump can be between 0.3 mm and 1 mm or other suitable size and have a generally elliptical half-hemispherical shape.

In some embodiments, each rib can be arcuate in shape or have another suitable shape (e.g. be a linearly extending wall, etc.). Each rib can have at least one groove or recess defined in a top of the rib when the rib is on the top of the body. Each rib can have at least one groove or recess defined in a bottom of the rib when the rib is on the bottom of the body. In some embodiments, the rib can be integral with an inner side of the hump to which the rib is adjacent. In other embodiments, the rib can be in contact with the hump to which the rib is adjacent.

Embodiments of the cutting insert can be composed of a metal, a ceramic material, an alloy, steel, carbide material, tungsten carbide, cubic boron nitride (CBN) material, or other suitable material.

In a second aspect, the sides can include a fourth side and the corners can include a fourth corner. The third corner can be between the third side and the fourth side and the fourth corner can be between the fourth side and the first side. In such embodiments, the body may have a generally rectangular shape (e.g. square-like shape, rhombus-like shape, rectangle type shape, or type of generally polygonal shaped body with corners that may be rounded, etc.).

In a third aspect, the body can only include three sides and the third corner can be between the third side and the first side. In such embodiments, the body can be generally triangular shaped or may have another type of polygonal shape with corners that may be rounded, etc.

In a fourth aspect, the top of the body can also have a hump positioned adjacent the second corner and a rib positioned adjacent the second corner such that the hump positioned adjacent the second corner is positioned between an outer edge of the second corner and the rib positioned adjacent the second corner, a hump positioned adjacent the third corner and a rib positioned adjacent the third corner such that the hump positioned adjacent the third corner is positioned between an outer edge of the third corner and the rib positioned adjacent the third corner, and a hump positioned adjacent the fourth corner and a rib positioned adjacent the fourth corner such that the hump positioned adjacent the fourth corner is positioned between an outer edge of the fourth corner and the rib positioned adjacent the fourth corner for embodiments that may have four corners or more than four corners.

In other embodiments that may have only three corners, the top of the body can have a hump positioned adjacent the second corner and a rib positioned adjacent the second corner such that the hump positioned adjacent the second corner is positioned between an outer edge of the second corner and the rib positioned adjacent the second corner, and a hump positioned adjacent the third corner and a rib positioned adjacent the third corner such that the hump positioned adjacent the third corner is positioned between an outer edge of the third corner and the rib positioned adjacent the third corner.

In a fifth aspect, the bottom of the body for an embodiment having four or more corners can have a hump positioned adjacent the first corner and a rib positioned adjacent the first corner such that the hump positioned adjacent the first corner is positioned between an outer edge of the first corner and the rib positioned adjacent the first corner, a hump positioned adjacent the second corner and a rib positioned adjacent the second corner such that the hump positioned adjacent the second corner is positioned between an outer edge of the second corner and the rib positioned adjacent the second corner, a hump positioned adjacent the third corner and a rib positioned adjacent the third corner such that the hump positioned adjacent the third corner is positioned between an outer edge of the third corner and the rib positioned adjacent the third corner, and a hump positioned adjacent the fourth corner and a rib positioned adjacent the fourth corner such that the hump positioned adjacent the fourth corner is positioned between an outer edge of the fourth corner and the rib positioned adjacent the fourth corner.

In other embodiments that may only have three corners, the bottom of the body can have a hump positioned adjacent the first corner and a rib positioned adjacent the first corner such that the hump positioned adjacent the first corner is positioned between an outer edge of the first corner and the rib positioned adjacent the first corner, a hump positioned adjacent the second corner and a rib positioned adjacent the second corner such that the hump positioned adjacent the second corner is positioned between an outer edge of the second corner and the rib positioned adjacent the second corner, a hump positioned adjacent the third corner and a rib positioned adjacent the third corner such that the hump positioned adjacent the third corner is positioned between an outer edge of the third corner and the rib positioned adjacent the third corner.

In a sixth aspect, the top of the body can have an inner groove and an outer groove defined adjacent each of the sides. The inner groove can have a different radius than the outer groove. In some embodiments, the bottom of the body can have a similar configuration. For example, the bottom of the body can have an inner groove and an outer groove defined adjacent each of the sides wherein inner grooves of the bottom can have a different radius than the outer grooves of the bottom.

In a seventh aspect, the top can have a first channel defined adjacent a middle region of the first side, a second channel defined adjacent a middle region of the second side, a third channel defined adjacent a middle region of the third side, and a fourth channel defined adjacent a middle region of the fourth side. In embodiment that may only have three sides, the top can have a first channel defined adjacent a middle region of the first side, a second channel defined adjacent a middle region of the second side, and a third channel defined adjacent a middle region of the third side.

In some embodiments, the bottom can have a similar configuration. For example, the bottom can have a first channel defined adjacent a middle region of the first side, a second channel defined adjacent a middle region of the second side, a third channel defined adjacent a middle region of the third side, and a fourth channel defined adjacent a middle region of the fourth side. In embodiment that may only have three sides, the bottom can have a first channel defined adjacent a middle region of the first side, a second channel defined adjacent a middle region of the second side, and a third channel defined adjacent a middle region of the third side.

In some embodiments, the top can also include a plurality of inner grooves and outer grooves. For example, the top can have a first inner groove and a first outer groove defined to extend from adjacent the hump positioned adjacent the first corner to the first channel and a second inner groove and a second outer groove defined to extend from adjacent the first channel to adjacent the hump positioned adjacent the second corner, a third inner groove and a third outer groove defined to extend from adjacent the hump positioned adjacent the second corner to the second channel and a fourth inner groove and a fourth outer groove defined to extend from adjacent the second channel to adjacent the hump positioned adjacent the third corner, a fifth inner groove and a fifth outer groove defined to extend from adjacent the hump positioned adjacent the third corner to the third channel and a sixth inner groove and a sixth outer groove defined to extend from adjacent the third channel to adjacent the hump positioned adjacent the fourth corner, and a seventh inner groove and a seventh outer groove defined to extend from adjacent the hump positioned adjacent the fourth corner to the fourth channel and an eighth inner groove and an eighth outer groove defined to extend from adjacent the fourth channel to adjacent the hump positioned adjacent the first corner.

In some embodiments, the bottom can also have a similar configuration of inner and outer grooves. For example, the bottom can have a first inner groove and a first outer groove defined to extend from adjacent the hump positioned adjacent the first corner to the first channel of the bottom and a second inner groove and a second outer groove defined to extend from adjacent the first channel to adjacent the hump of the bottom positioned adjacent the second corner, a third inner groove and a third outer groove defined to extend from adjacent the hump of the bottom positioned adjacent the second corner to the second channel of the bottom and a fourth inner groove and a fourth outer groove defined to extend from adjacent the second channel of the bottom to adjacent the hump of the bottom positioned adjacent the third corner, a fifth inner groove and a fifth outer groove defined to extend from adjacent the hump of the bottom positioned adjacent the third corner to the third channel of the bottom and a sixth inner groove and a sixth outer groove defined to extend from adjacent the third channel of the bottom to adjacent the hump positioned adjacent the fourth corner, and a seventh inner groove and a seventh outer groove defined to extend from adjacent the hump of the bottom positioned adjacent the fourth corner to the fourth channel of the bottom and an eighth inner groove and an eighth outer groove defined to extend from adjacent the fourth channel of the bottom to adjacent the hump of the bottom positioned adjacent the first corner.

In an eighth aspect, the top can also have a tapered land that extends along the first side adjacent a tapered cutting edge that extends along the first side adjacent the top, a tapered land that extends along the second side adjacent a tapered cutting edge that extends along the second side adjacent the top, a tapered land that extends along the third side adjacent a tapered cutting edge that extends along the third side adjacent the top, and a tapered land that extends along the fourth side adjacent a tapered cutting edge that extends along the fourth side adjacent the top.

In embodiments that may only have three sides, the top can have a tapered land that extends along the first side adjacent a tapered cutting edge that extends along the first side adjacent the top, a tapered land that extends along the second side adjacent a tapered cutting edge that extends along the second side adjacent the top, and a tapered land that extends along the third side adjacent a tapered cutting edge that extends along the third side adjacent the top.

In some embodiments, the bottom can have a similar configuration as the top such that the bottom also has a tapered land that extends along the first side adjacent a tapered cutting edge that extends along the first side adjacent the bottom, a tapered land that extends along the second side adjacent a tapered cutting edge that extends along the second side adjacent the bottom, a tapered land that extends along the third side adjacent a tapered cutting edge that extends along the third side adjacent the bottom, and a tapered land that extends along the fourth side adjacent a tapered cutting edge that extends along the fourth side adjacent the bottom. In embodiments that may only have three sides, the bottom can have a tapered land that extends along the first side adjacent a tapered cutting edge that extends along the first side adjacent the bottom, a tapered land that extends along the second side adjacent a tapered cutting edge that extends along the second side adjacent the bottom, and a tapered land that extends along the third side adjacent a tapered cutting edge that extends along the third side adjacent the bottom.

In a ninth aspect, the body can have a central aperture and the top can have at least one seating surface defined adjacent a mouth that is in communication with the central aperture. The bottom can also have at least one seating surface defined adjacent a mouth that is in communication with the central aperture.

In a tenth aspect, the cutting inert of the first aspect can include one or more features of the second aspect, the third aspect, the fourth aspect, the fifth aspect, the sixth aspect, the seventh aspect, the eighth aspect, and/or the ninth aspect. Embodiments can also include other features or elements. Examples of such features or elements can be appreciated from the exemplary embodiments discussed herein, for instance.

In an eleventh aspect, a cutting apparatus is provided. The cutting apparatus can include a member having a holder and a cutting insert attached to the holder. In some embodiments, the cutting insert can be an embodiment of the cutting insert of the first aspect or ninth aspect.

For example, in some embodiments of the apparatus, the cutting insert can include a body having a top and a bottom. The body can also have a plurality of sides and a plurality of corners. Each of the sides can extend from the top to the bottom and each of the corners can extend from the top to the bottom. The sides can include a first side, a second side, and a third side and the corners can include a first corner, a second corner, and a third corner. The first corner can be between the first side and the second side, the second corner can be between the second side and the third side, and the third corner can be adjacent the third side. The top of the body can also have a hump positioned adjacent the first corner and a rib positioned adjacent the first corner such that the hump positioned adjacent the first corner is positioned between an outer edge of the first corner and the rib positioned adjacent the first corner.

In some embodiments, the sides of the body of the cutting insert can include a fourth side and the corners of the body of the cutting insert can include a fourth corner such that the third corner is between the third side and the fourth side and the fourth corner is between the fourth side and the first side. In other embodiments that may only have three sides, the third corner can be between the third side and the first side.

In some embodiments, the top of the body can have additional humps and ribs. For example, the top can have a hump positioned adjacent the second corner and a rib positioned adjacent the second corner such that the hump positioned adjacent the second corner is positioned between an outer edge of the second corner and the rib positioned adjacent the second corner, a hump positioned adjacent the third corner and a rib positioned adjacent the third corner such that the hump positioned adjacent the third corner is positioned between an outer edge of the third corner and the rib positioned adjacent the third corner, and a hump positioned adjacent the fourth corner and a rib positioned adjacent the fourth corner such that the hump positioned adjacent the fourth corner is positioned between an outer edge of the fourth corner and the rib positioned adjacent the fourth corner. As discussed above, the bottom can have a similar configuration of humps and ribs adjacent different corners as well.

In a twelfth aspect, the top of the body can include channels and/or grooves. For example, the top of the body of the cutting insert can have a first channel defined adjacent a middle region of the first side, a second channel defined adjacent a middle region of the second side, a third channel defined adjacent a middle region of the third side, and a fourth channel defined adjacent a middle region of the fourth side. The top of the body of the cutting insert can also have a first inner groove and a first outer groove defined to extend from adjacent the hump positioned adjacent the first corner to the first channel and a second inner groove and a second outer groove defined to extend from adjacent the first channel to adjacent the hump positioned adjacent the second corner, a third inner groove and a third outer groove defined to extend from adjacent the hump positioned adjacent the second corner to the second channel and a fourth inner groove and a fourth outer groove defined to extend from adjacent the second channel to adjacent the hump positioned adjacent the third corner, a fifth inner groove and a fifth outer groove defined to extend from adjacent the hump positioned adjacent the third corner to the third channel and a sixth inner groove and a sixth outer groove defined to extend from adjacent the third channel to adjacent the hump positioned adjacent the fourth corner, and a seventh inner groove and a seventh outer groove defined to extend from adjacent the hump positioned adjacent the fourth corner to the fourth channel and an eighth inner groove and an eighth outer groove defined to extend from adjacent the fourth channel to adjacent the hump positioned adjacent the first corner.

In a thirteenth aspect, the cutting insert can also have at least one tapered land. For example, embodiments can include a cutting insert that has a top that has a tapered land that extends along the first side and a tapered cutting edge that extends along the first side adjacent the top, a tapered land that extends along the second side and a tapered cutting edge that extends along the second side adjacent the top, a tapered land that extends along the third side and a tapered cutting edge that extends along the third side adjacent the top, and/or a tapered land that extends along the fourth side and a tapered cutting edge that extends along the fourth side adjacent the top.

Other embodiments of the cutting apparatus can also include other features or elements. Examples of the other features or elements that may be included in embodiments of the cutting apparatus can be appreciated from the exemplary embodiments discussed herein, for instance.

These and other embodiments shall be described in more detail herein and in the drawings that show exemplary embodiments. Therefore, other details, objects, and advantages will become apparent as the following description of certain present preferred embodiments thereof and certain present preferred methods of practicing the same proceeds.

### BRIEF DESCRIPTION OF THE DRAWINGS

Exemplary embodiments of a cutting apparatus, a cutting insert, chip breaking mechanism, and methods of making and using the same are shown in the accompanying drawings. It should be appreciated that like reference numbers used in the drawings may identify like components.:

FIG. 1 is a perspective view of an exemplary embodiment of a cutting tool 1 having a cutting insert 4.

FIG. 2 is a perspective view of a first exemplary embodiment of the cutting insert 4.

FIG. 3 is a top view of the first exemplary embodiment of the cutting insert 4.

FIG. 4 is front view of the first exemplary embodiment of the cutting insert 4. A rear view of the first exemplary embodiment of the cutting insert 4 is a mirror image of the front view of FIG. 4.

FIG. 5 is a left side view of the first exemplary embodiment of the cutting insert 4. A right side view of the first exemplary embodiment of the cutting insert 4 is a mirror image of the left side view of FIG. 5.

FIG. 6 is a cross-sectional view of the first exemplary embodiment of the cutting insert 4 taken along line A-A shown in FIG. 3. FIG. 6 also includes an enlarged view of an exemplary chip breaking mechanism 6.

FIG. 7 is a perspective view of the first exemplary embodiment of the cutting insert 4.

FIG. 8 is a perspective view of a second exemplary embodiment of the cutting insert 4.

FIG. 9 is a perspective view of a third exemplary embodiment of the cutting insert 4.

### DESCRIPTION

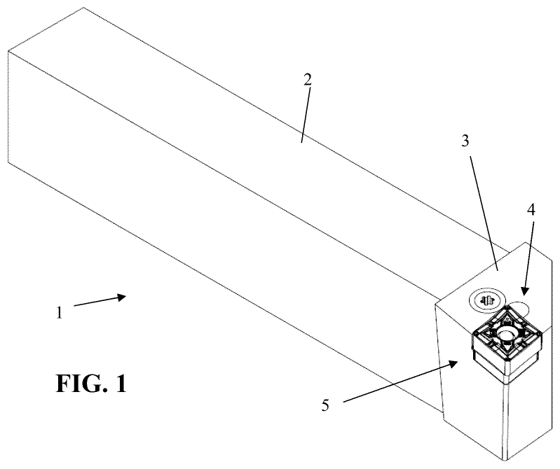

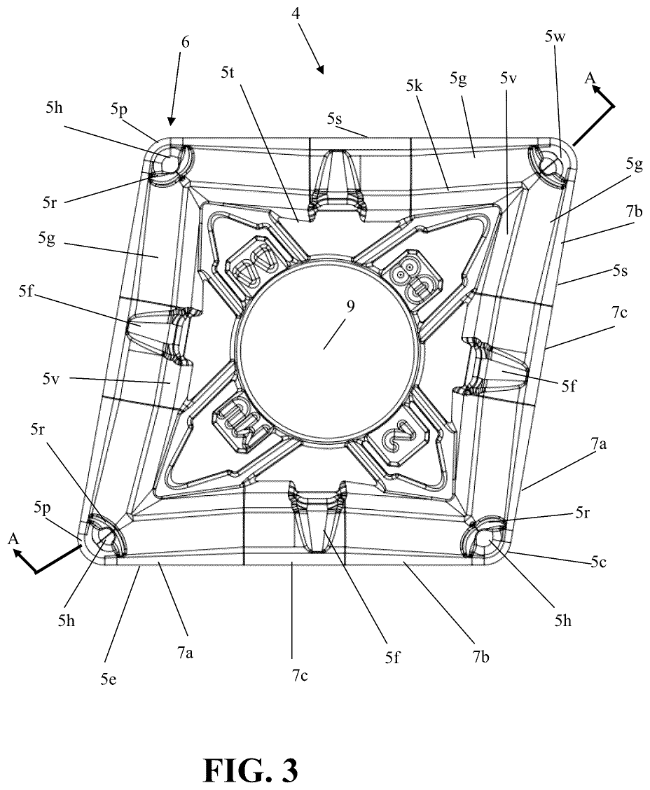

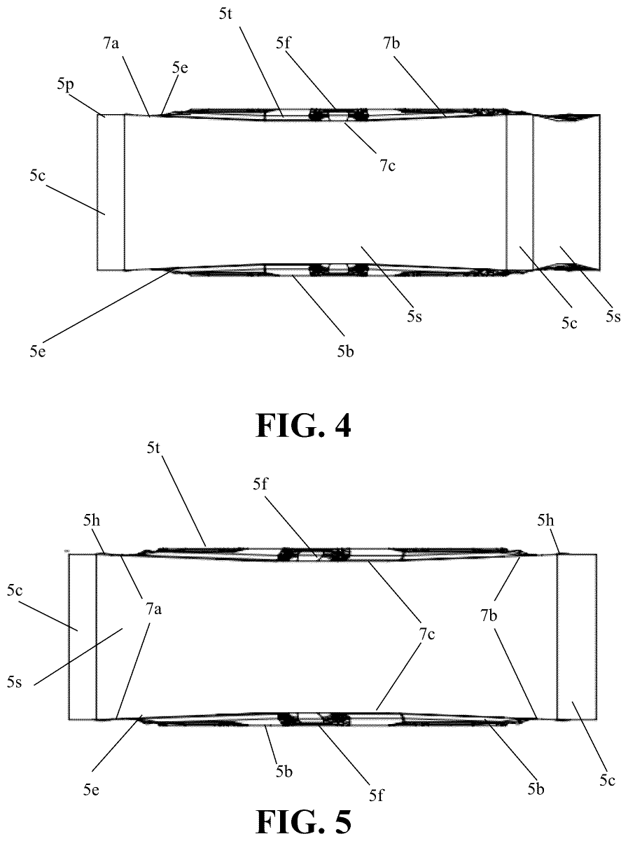

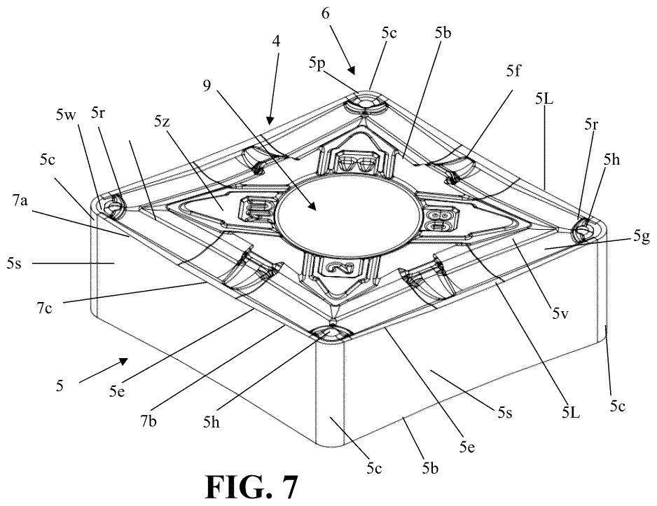

Referring to FIG. 1 through FIG. 9, a cutting tool 1 can include an elongated member 2 that include a holder 3 positioned to retain and hold a cutting insert 4. The holder 3 can be attached to a distal end of the member 2, for example. The holder 3 can be configured to retain a cutting insert 4 via one or more fasteners (e.g. screw, bolt, etc.).

The cutting insert 4 can have a body 5 that is affixed to the holder 3. The body 5 of the cutting insert 4 can have a central aperture 9 that is sized and configured so a fastener or other attachment element can be passed through the aperture 9 for attachment of the cutting insert 4 to the holder 3. The cutting insert can also be clamped into position via clamping elements that can contact or otherwise engage seating surfaces 5z defined adjacent to the central aperture 9. The clamping mechanism can help affix the cutting insert 4 to the holder 3 so that the cutting insert is not moveable relative to the holder 3.

The holder 3 can retain the cutting insert 4 so that the cutting insert 4 does not move while it engages a workpiece to cut the work piece. In some embodiments, the workpiece may be rotated, or turned, while the cutting insert 4 is held in a non-rotating position while the holder 3 is linearly moved along a surface of the workpiece, for example. The cutting that is provided can help shape the workpiece and/or finish the workpiece. In some embodiments, the cutting insert 4 is attachable to a moveable tool holder of a CNC machine or other type of cutting machine. In such embodiments, the tool holder 3 may be linearly moveable while a workpiece is rotated. In other embodiments, the tool holder may be maintained in a stationary position and the workpiece can be rotated and/or linearly moved relative to the cutting insert for cutting of the workpiece.

In some embodiments, the tool holder 3 and member 2 can include an internal coolant conduit for distribution of a coolant liquid onto the cutting insert 4. In other embodiments, an external coolant distribution device can be positioned to output coolant liquid onto the cutting insert 4 during cutting operations.

The cutting insert 4 can include one or more chip breaking mechanisms 6 to help break chips during the cutting operation (e.g. cutting of a workpiece). The body 5 of the cutting insert 4 can be an integral body that is formed to have one or more chip breaking mechanisms 6 defined thereon, for example. The body 5 can be comprised of metal, a ceramic material, an alloy, steel, carbide material, tungsten carbide, cubic boron nitride (CBN) material, or other suitable material.

The body 5 of the cutting insert 4 can have a plurality of sides 5s that extend between a top 5t and a bottom 5b of the body. The body 5 can also include corners 5c positioned between adjacent sides 5s (each of the corners 5c can be positioned between two immediately adjacent sides 5s). The corners 5c can also extend between the bottom 5b and the top 5t of the body 5. In some embodiments, the body 5 can have a rectangular shape (e.g. rhombus-like shape, square shape, other type of rectangular shape). Other embodiments of the body 5 can have a triangular shape, pentagonal shape, or other type of polygonal shape.

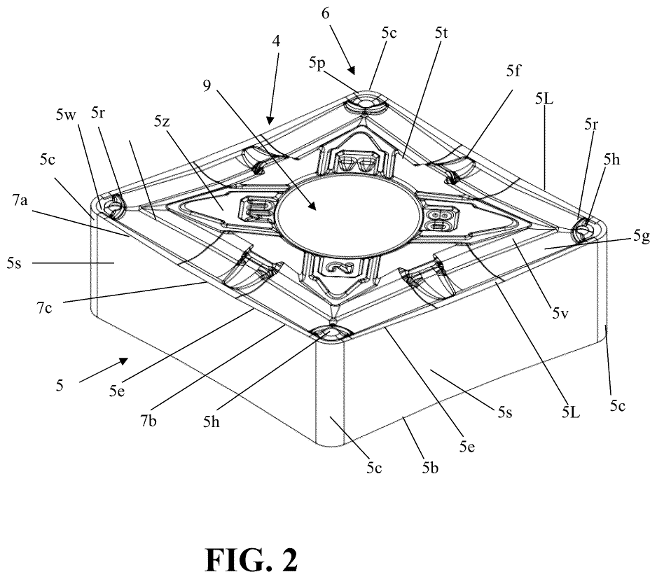

In some embodiments, the body 5 can have a first side 5s a second side 5s, a third side 5s and a fourth side 5s as well as a first corner 5c between the first and second sides 5s, a second corner 5c between the second and third sides 5s, a third corner 5c between the third and fourth sides 5s, and a fourth corner 5c between the fourth and first sides 5s. The corners 5c can be rounded so that each corner 5c defines a curved surface that extends between the top 5t and bottom 5b as well as between the adjacent sides 5s that the corner 5c is positioned between. FIG. 2 through FIG. 7 illustrate an exemplary embodiment of a body 5 having such sides and corners, for example.

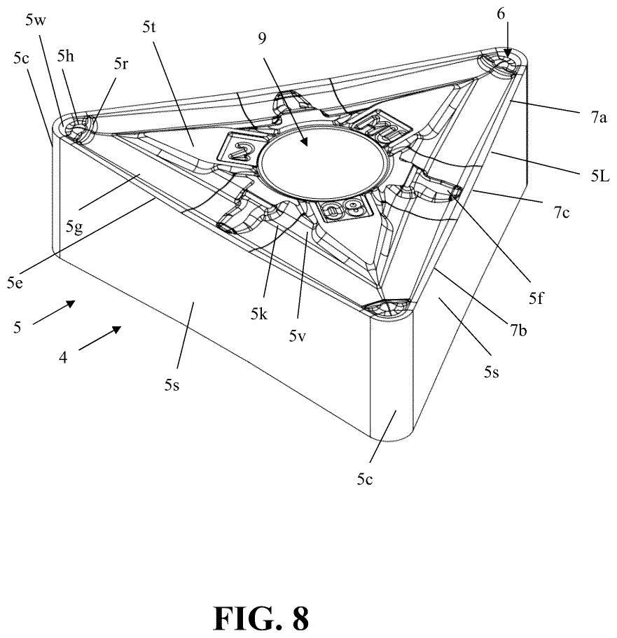

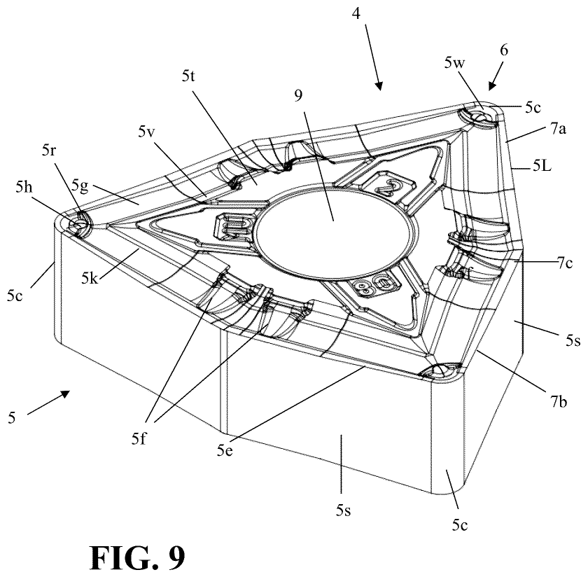

Other embodiments can have a first side 5s, second side 5s, and third side 5s as well as a first corner 5c between the first and second sides 5s, a second corner between the second and third sides 5s, and a third corner 5c between the third and first sides 5s. The exemplary embodiments of FIG. 8 and FIG. 9 illustrate examples of such embodiments.

Other embodiments of the body 5 may utilize more than four sides and more than four corners. For example, embodiments can have five sides 5s and five corners 5c, six sides 5s and six corners 5c, or other number of sides 5s and corners 5c. The shape of the body 5 can be any number of other shapes and sizes.

The top 5t and bottom 5b of the body 5 of the cutting insert 4 can have a similar profile or the same profile. For example, the top 5t can include a profile that includes a mouth of the aperture 9 and a plurality of seating surfaces 5z positioned around the inner aperture 9 that are sized to receive clamping elements of a clamping member that the holder 3. As noted above, the top 5t can also be considered a first face of the body 5 and the bottom 5b can be considered a second face that is opposite the first face of the body 5.

Each side 5s can have a number of features defined in the top portion of the side (e.g. the top 5t can include one or more features at or adjacent the side 5s). For example, each side 5s can have an upper land 5L that is defined at an upper outer cutting edge 5e of the side 5s at the top 5t or adjacent the top 5t of the body 5. The land 5L can be shaped to include a recessed intermediate portion 7c that is between a first side portion 7a of the land 5L and a second side portion 7b of the land 5L. The land 5L can extend adjacent to the cutting edge 5e of the side, which can be tapered.

The first side portion 7a of the land 5L can extend from adjacent to a corner 5c to the intermediate portion 7c of the land 5L at a pre-selected angle or recessed curvature and the second side portion 7b can extend from the intermediate portion 7c to the corner 5c opposite the first side portion 7a at a pre-selected angle or curvature to define a variable sized land 5L for each side 5 adjacent the top 5t of the body. The cutting edge 5e can extend below the land 5L and also be tapered similarly to the land 5L.

Each side 5s can also have at least one channel 5f positioned adjacent or at the intermediate portion 7c of the land 5L to help direct chips away from the cutting insert 4. Each channel 5f can be ramped and/or otherwise shaped to help facilitate the direction of chips away from the cutting insert 4.

The top 5t can also include other elements. For example, there can be an outer groove 5g and an inner groove 5v positioned between the land 5L and the aperture 9 for each side 5s of the body 5. The outer groove 5g can be positioned to extend along the side from adjacent a first end of the side 5s that is in contact with a corner 5c to an opposite end of the side 5s that is adjacent a different corner 5c. The outer groove 5g can be between the land 5L and the inner groove 5v. The inner groove 5v can also be positioned to extend from adjacent the first end of the side 5s that is in contact with a corner 5c to an opposite end of the side 5s that is adjacent a different corner 5c.

The second inner groove 5v can have a different radius than the first outer groove 5g. For example, the radius of the first outer groove 5g can be larger than the radius of the second inner groove 5v. In some embodiments, the radius of the first outer groove 5g can be between 0.1 mm and 0.25 mm and the radius of the second inner groove 5v can be between 0.05 mm and 0.1 mm.

A step 5k can be defined between the inner groove 5v and the outer groove 5g as well. The step 5k can be a planar or curved upper portion of the top 5t adjacent each side 5s that extends along the inner groove 5v and outer groove 5g. The top 5t can be defined so that there can be multiple pairs of inner and outer grooves 5v and 5g positioned adjacent each side 5s. There can be a step 5k defined between immediately adjacent pairs of inner and outer grooves 5v and 5g that can be defined in different portions of the top 5t adjacent different sides 5s of the body 5 as well. Each step 5k can extend from an inner side of the outer groove 5g to an outer side of the inner groove 5v. The top 5t can have a respective land 5L, at least one outer groove 5g, at least one step 5k, and at least one inner groove 5v adjacent to or at each side 5s that extends between corners 5c positioned adjacent to opposite ends of the side 5s.

The top 5t can also include a chip breaking mechanism 6 adjacent each corner 5c between ends of immediately adjacent sides 5s. Each chip breaking mechanism 6 can include an outer hump 5h positioned adjacent to an inner rib 5r that can be positioned and defined to reinforce the inner side of the hump 5h. The upper end of the rib 5r can have a groove or recess defined therein in some embodiments to provide improved rigidity or stiffness in some embodiments.

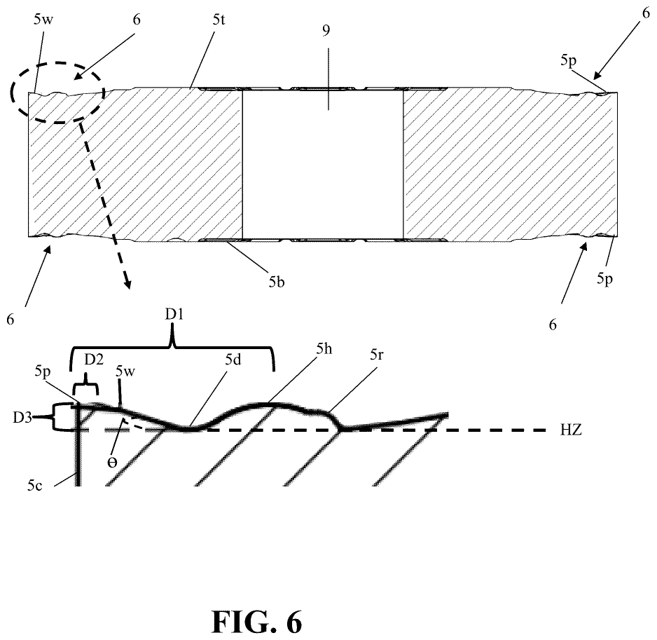

The hump 5h can be positioned between an outer peripheral side of the corner 5c and the rib 5r. In some embodiments, a ramped hump feeding surface 5w can extend from the corner 5c to which the hump 5h is adjacent to the hump 5h along the top 5t at a pre-selected angle θ to facilitate the hump 5h being able to engage with a workpiece for breaking chips during a cutting operation. The sizing and configuration of the hump 5h and ramped hump feeding surface 5w may best be appreciated from the enlarged cross-section view shown in FIG. 6.

As may best be seen from FIG. 6, the ramped hump feed surface can extend along a pre-selected angle relative to horizontal HZ to a depth location 6d of a recess between the outermost surface of the corner 5c. The depth location can be positioned so that the depth location 6d is located a pre-selected depth D3 from the top surface of the corner 5c. This preselected depth D3 can be between 0.14 mm and 0.10 mm (e.g. 0.12-0.11 mm, etc.).

The upper surface of the corner can extend a pre-selected outer distance D2 from the outer edge of the corner to an inward location at which the ramped hump feed surface 5w extends into the body 5 to the pre-selected depth D3 along the pre-selected angle θ to the depth location 6d. The pre-selected angle can be in the range of greater than 0° to 20° (e.g. 5°-20°, 5°-15°, etc.) or other suitable angle. The upper surface of the corner 5c that can extend the preselected outer distance D2 from the outer edge of the corner to an inward location at which the ramped hump feed surface 5w begins can be a planar surface that may define a lip adjacent the hump 5h so that the depth location 6d of the recess formed via the ramped hum feed surface 5w is located between the formed lip 5p and the hump 5w. The lip 5p can extend the pre-selected outer distance D2, which can be between greater that 0.05 mm to 0.3 mm (e.g. 0.1-0.2 mm).

The depth location 6d can be positioned so that the depth location 6d is located a pre-selected depth D3 from the lip 5p of the corner 5c. As noted above, this pre-selected depth D3 can be between 0.14 mm and 0.10 mm (e.g. 0.12-0.11 mm, etc.).

The hump 5h can be formed to extend from depth location 6d to an apex of the hump, or top part of the hump such that the apex of the hump is a pre-selected distance D1 from the outer edge of the corner 5c. The pre-selected distance D1 that the hump 5h is located from the outer edge of the corner 5c to which the hump 5h is adjacent can be between 1.0 mm and 0.5 mm (e.g. 0.8-0.9 mm, etc.).

Each side 5s can have a respective inner groove 5v and outer groove 5g extend from adjacent a corner 5c of the first end of the side 5s to an opposite corner 5c adjacent the second end of the side 5s opposite its first end. In some embodiments, at least one channel 5f can be positioned adjacent a middle region of the inner and outer grooves 5v and 5g. In such embodiments, each side 5s can have a first set of inner and outer grooves 5v and 5g that extend from adjacent a corner 5c and the hump 5h and rib positioned near that corner 5c at a first end of the side 5s to the channel(s) 5f and a second set of inner and outer grooves 5v and 5g that extend from the channel(s) 5f to the second end of the side 5s adjacent a corner 5c and the hump 5h and rib 5r positioned adjacent that corner 5c.

Each of the humps 5h of the top 5t can be elliptical in shape. In some embodiments, the diameter or width of the humps can be between 0.3 mm and 1 mm or other suitable size and have a generally elliptical half-hemispherical shape adjacent to an inner rib 5r that is positioned at or integral with the hump 5h and is arcuate or curved in shape as it extends from adjacent one side of a corner 5c to adjacent an opposite side of the corner 5c along an inner side of the hump 5h to which the rib 5r is adjacent. In some embodiments, the ribs 5r can be 0.3 mm to 1 mm long and be 0.1 mm to 0.4 mm thick. In other embodiments, the ribs 5r can have other shapes and sizes (e.g. be more linear in shape or polygonal in shape and/or have a different sizing, etc.) and the humps 5h can also have different shapes and sizes (e.g. be more half-spherical or polygonal in shape, have a different width or diameter, etc.).

The top 5t can also have one or more seating surfaces 5z positioned inwardly between the inner grooves 5v of each side 5s and the inner aperture 9. The seating surfaces 5z can surround a periphery of the aperture 9. The seating surfaces 5z can be recessed relative to the inner groove 5v and be structured to provide a seating surface that can accommodate high depth of cuts and high feed rates of material. The seating surfaces 5z can also include ornamental items or other markings to help identify the type of cutting insert and/or other features of the cutting insert 4.

The bottom 5b of the body 5 can have the same profile as the top 5t. Each side 5s can have the same profiles defined in the bottom 5b as the sides 5s have defined in the top 5t such that the top 5t is a mirror image of the bottom 5b of the body.

For example, the bottom 5b of the body 5 can include a profile that includes a mouth of the aperture 9 and a plurality of seating surfaces 5z positioned around the inner aperture 9 that are sized to receive clamping elements of a clamping member that the holder 3.

Each side 5s can have a number of features defined in the bottom portion of the side 5s and/or the bottom 5b can have a number of features defined therein adjacent each side 5s. For example, the bottom 5b can have a land 5L that is defined thereon at each side 5s at an outer cutting edge 5e of the side 5s at the bottom 5b or adjacent the bottom 5b of the body 5. The land 5L can be shaped to include a recessed intermediate portion 7c that is between a first side portion 7a of the land 5L and a second side portion 7b of the land 5L. The land 5L can extend adjacent to the cutting edge 5e of the side, which can be tapered.

The first side portion 7a of the land 5L can extend from adjacent to a corner 5c to the intermediate portion 7c of the land 5L at a pre-selected angle or recessed curvature and the second side portion 7b can extend from the intermediate portion 7c to the corner 5c opposite the first side portion 7a at a pre-selected angle or curvature to define a variable sized land 5L for each side 5 adjacent the bottom 5b of the body. The cutting edge 5e can extend adjacent the land 5L and also be tapered similarly to the land 5L.

Each side 5s can also have at least one channel 5f positioned adjacent or at the intermediate portion 7c of the land 5L at the bottom 5b of the side 5s to help direct chips away from the cutting insert 4. Each channel 5f can be ramped and/or otherwise shaped to help facilitate the direction of chips away from the cutting insert 4.

The bottom 5b can also include an outer groove 5g and an inner groove 5v positioned between the land 5L and the aperture 9 for each side 5s of the body 5. The outer groove 5g can be positioned to extend along the side 5s from adjacent a first end of the side 5s that is in contact with a corner 5c to an opposite end of the side 5s that is adjacent a different corner 5c. The outer groove 5g can be between the land 5L and the inner groove 5v. The inner groove 5v can also be positioned to extend from adjacent the first end of the side 5s that is in contact with a corner 5c to an opposite end of the side 5s that is adjacent a different corner 5c. The second inner groove 5v can have a different radius than the first outer groove 5g. For example, the radius of the first outer groove 5g can be larger than the radius of the second inner groove 5v. In some embodiments, the radius of the first outer groove 5g can be between 0.1 mm and 0.25 mm and the radius of the second inner groove 5v can be between 0.05 mm and 0.1 mm.

A step 5k of the bottom 5b can be defined between the inner groove 5v and the outer groove 5g of the bottom 5b of the body 5 as well. The step 5k can be a planar or curved upper portion of the bottom 5b adjacent each side 5s that extends along the inner groove 5v and outer groove 5g. There can be multiple pairs of inner and outer grooves 5v and 5g positioned adjacent each side 5s. There can be a step 5k defined between immediately adjacent pairs of inner and outer grooves 5v and 5g that can be defined in different portions of the bottom 5b adjacent different sides 5s of the body 5 as well. Each step 5k can extend from an inner side of the outer groove 5g to an outer side of the inner groove 5v along the bottom 5b, for example. The bottom 5b can have a respective land 5L, at least one outer groove 5g, at least one step 5k, and at least one inner groove 5v adjacent to or at each side 5s that extends between corners 5c positioned adjacent to opposite ends of the side 5s.

The bottom 5b can also include a chip breaking mechanism 6 adjacent each corner 5c between ends of immediately adjacent sides 5s. Each chip breaking mechanism 6 can include an outer hump 5h positioned adjacent to an inner rib 5r that can be positioned and defined to reinforce the inner side of the hump 5h. Each the rib 5r can have a groove defined therein in some embodiments to provide improved rigidity or stiffness in some embodiments.

Each hump 5h of the bottom 5b can be positioned between an outer peripheral side of a respective corner 5c and the rib 5r for the bottom 5b of the body 5. Each of the humps 5h of the bottom 5b can also be elliptical in shape. In some embodiments, the diameter or width of the humps 5h of the bottom 5b can be between 0.3 and 1 mm or other suitable size and have a generally elliptical half-hemispherical shape adjacent to an inner rib 5r that is positioned at or integral with the hump 5h and is arcuate or curved in shape as it extends from adjacent one side of a corner 5c to adjacent an opposite side of the corner 5c along an inner side of the hump 5h to which the rib 5r is adjacent. In some embodiments, the ribs 5r of the bottom 5b can be 0.3 mm to 1 mm long and be 0.1 mm to 0.4 mm thick. In other embodiments, the ribs 5r of the bottom 5b can have other shapes and sizes (e.g. be more linear in shape or polygonal in shape and/or have a different sizing, etc.) and the humps 5h of the bottom 5b can also have different shapes and sizes (e.g. be more half-spherical or polygonal in shape, have a different width or diameter, etc.).

In some embodiments, a ramped hump feeding surface 5w of the bottom 5b can extend from the corner 5c to which the hump 5h is adjacent to the hump 5h along the bottom 5b at a pre-selected angle θ to facilitate the hump 5h being able to engage with a workpiece for breaking chips during a cutting operation. For instance, the ramped hump feed surface 5w can extend along a pre-selected angle θ relative to horizontal HZ to a depth location 6d of a recess in the bottom surface of the corner 5c. The depth location can be positioned so that the depth location 6d is located a pre-selected depth D3 from the surface of the corner 5c. This preselected depth D3 can be between 0.14 mm and 0.10 mm (e.g. 0.12-0.11 mm, etc.) into the body 5 relative to the bottom surface of the corner 5c at or adjacent the bottom 5b.

A lip 5p can extend a pre-selected outer distance D2 from the outer edge of the corner 5c to an inward location of the bottom 5b at which the ramped hump feed surface 5w extends into the body 5 to the pre-selected depth D3 along the pre-selected angle θ to the depth location 6d. The pre-selected angle can be in the range of greater than 0° to 20° (e.g. 5°-20°, 5°-15°, etc.) or other suitable angle. The surface of the corner 5c that can extend the pre-selected outer distance D2 from the outer edge of the corner to an inward location at which the ramped hump feed surface 5w begins to define the lip 5p can be a planar surface that may define the lip 5p adjacent the hump 5h so that the depth location 6d of the recess formed via the ramped hump feed surface 5w is located between the formed lip 5p and the hump 5w. The lip 5p can extend the pre-selected outer distance D2, which can be between greater that 0.05 mm to 0.3 mm (e.g. 0.1-0.2 mm).

The hump 5h can be formed to extend from depth location 6d to an apex of the hump such that the apex of the hump is a pre-selected distance D1 from the outer edge of the corner 5c. The pre-selected distance D1 that the hump 5h is located from the outer edge of the corner 5c to which the hump 5h is adjacent can be between 1.0 mm and 0.5 mm (e.g. 0.8-0.9 mm, etc.).

A bottom region of each side 5s can also have a respective inner groove 5v and outer groove 5g that extends from adjacent a corner 5c of the first end of the side 5s to an opposite corner 5c adjacent the second end of the side 5s opposite its first end. In some embodiments, at least one channel 5f can be positioned adjacent a middle region of the inner and outer grooves 5v and 5g. In such embodiments, each side 5s can have a first set of inner and outer grooves 5v and 5g that extend from adjacent a corner 5c and the hump 5h and rib positioned near that corner 5c at a first end of the side 5s to the channel(s) 5f and a second set of inner and outer grooves 5v and 5g that extend from the channel(s) 5f to the second end of the side 5s adjacent a corner 5c and the hump 5h and rib 5r positioned adjacent that corner 5c.

The bottom 5b can also have one or more seating surfaces 5z positioned inwardly between the inner grooves 5v of each side 5s and the inner aperture 9. The seating surfaces 5z can surround a periphery of the aperture 9. The seating surfaces 5z can be recessed relative to the inner grooves 5v of the bottom 5b and be structured to provide a seating surface that can accommodate high depth of cuts and high feed rates of material. The seating surfaces 5z of the bottom 5b can also include ornamental items or other markings to help identify the type of cutting insert and/or other features of the cutting insert 4.

As can be seen from FIG. 8 and FIG. 9, the body 5 can a have other types of shapes and sizing. Some embodiments can also include multiple channels 5f positioned at a middle region of each side 5s adjacent an intermediate portion of the land 5L of that side 5s (see e.g. FIG. 9).

Embodiments of the cutting insert 4 can include a body 5 that has a number of features to provide a chip breaking mechanism 6. In some embodiments, a cutting insert for a cutting apparatus can include a body 5 having a top 5t and a bottom 5b. The top 5t can also be referred to a first face and the bottom 5b can also be referred to as a second face that is opposite the first face.

The body 5 can have a plurality of sides 5s and a plurality of corners 5c. Each of the sides 5s can extend from the top 5t to the bottom 5b and each of the corners 5c can extend from the top 5t to the bottom 5b. The sides 5s can include a first side 5s, a second side 5s, and a third side 5s, and the corners 5c can include a first corner 5c, a second corner 5c, and a third corner 5c. The first corner 5c can be between the first side 5s and the second side 5s, the second corner 5c can be between the second side 5s and the third side 5s, and the third corner 5c can be adjacent the third side 5s (e.g. between the third side 5s and the fourth side 5s or between the third side 5s and the first side 5s). In embodiments that may have a fourth side 5s, there may also be a fourth corner 5c which can be positioned between the third side 5s and the fourth side 5s. As noted above, other embodiments having other shapes (e.g. pentagonal, hexagonal, etc.) may had additional sides 5s and corners 5c as well.

The top 5t of the body 5 can have a hump 5h positioned adjacent the first corner 5c and a rib 5r positioned adjacent the first corner 5c such that the hump 5h positioned adjacent the first corner 5c is positioned between an outer edge of the first corner 5c and the rib 5r positioned adjacent the first corner 5c. In some embodiments, there can be a lip 5p positioned between the hump 5h adjacent the first corner 5c and the first corner 5c and there can be a ramped hump feeding surface 5w that extends from the lip 5p to the hump 5h (e.g. at a pre-selected angle θ relative to horizontal HZ).

The top 5t can also include other humps 5h and ribs. For example, the top 5t can include a hump positioned adjacent the second corner 5c and a rib 5r positioned adjacent the second corner 5c such that the hump 5h positioned adjacent the second corner 5c is positioned between an outer edge of the second corner 5c and the rib 5r positioned adjacent the second corner 5c. In some embodiments, there can be a lip 5p positioned between the hump 5h adjacent the second corner 5c and the second corner 5c and there can be a ramped hump feeding surface 5w that extends from the lip 5p to the hump 5h (e.g. at a pre-selected angle θ relative to horizontal HZ).

The top 5c can also include a hump 5h positioned adjacent the third corner 5c and a rib 5r positioned adjacent the third corner 5c such that the hump 5h positioned adjacent the third corner 5c is positioned between an outer edge of the third corner 5c and the rib 5r positioned adjacent the third corner. In some embodiments, there can be a lip 5p positioned between the hump 5h adjacent the third corner 5c and the third corner 5c and there can be a ramped hump feeding surface 5w that extends from the lip 5p to the hump 5h (e.g. at a pre-selected angle θ relative to horizontal HZ).

The top can also include a hump 5h positioned adjacent the fourth corner 5c and a rib 5r positioned adjacent the fourth corner 5c such that the hump 5h positioned adjacent the fourth corner 5c is positioned between an outer edge of the fourth corner 5c and the rib 5r positioned adjacent the fourth corner 5c. In some embodiments, there can be a lip 5p positioned between the hump 5h adjacent the fourth corner 5c and the fourth corner 5c and there can be a ramped hump feeding surface 5w that extends from the lip 5p to the hump 5h (e.g. at a preselected angle θ relative to horizontal HZ).

The bottom 5b of the body 5 can also include similar features. For example the bottom 5b of the body can include a hump 5h positioned adjacent the first corner 5c and a rib 5r positioned adjacent the first corner 5c such that the hump 5h positioned adjacent the first corner 5c is positioned between an outer edge of the first corner 5c and the rib 5r positioned adjacent the first corner 5c. The bottom 5b can also include a hump 5h positioned adjacent the second corner 5c and a rib 5r positioned adjacent the second corner 5c such that the hump 5h positioned adjacent the second corner 5c is positioned between an outer edge of the second corner 5c and the rib 5r positioned adjacent the second corner 5c. The bottom 5b can also include a hump 5h positioned adjacent the third corner 5c and a rib 5r positioned adjacent the third corner 5c such that the hump 5c positioned adjacent the third corner 5c is positioned between an outer edge of the third corner 5c and the rib 5r positioned adjacent the third corner. The bottom 5b can also include a hump 5h positioned adjacent the fourth corner 5c and a rib 5r positioned adjacent the fourth corner 5c such that the hump 5h positioned adjacent the fourth corner 5c is positioned between an outer edge of the fourth corner 5c and the rib 5r positioned adjacent the fourth corner 5c.

The top 5t of the body 5 can also have a first channel 5f defined adjacent a middle region of the first side 5s, a second channel 5f defined adjacent a middle region of the second side 5s, a third channel 5f defined adjacent a middle region of the third side 5s, and a fourth channel 5f defined adjacent a middle region of the fourth side 5s. The bottom 5b of the body 5 can also have a first channel 5f defined adjacent a middle region of the first side 5s, a second channel 5f defined adjacent a middle region of the second side 5s, a third channel 5f defined adjacent a middle region of the third side 5s, and a fourth channel 5f defined adjacent a middle region of the fourth side 5s.

The top 5t of the body 5 can also have a number of inner grooves 5v and outer grooves 5g. For example, the top 5t of the body 5 can have a first inner groove 5v and a first outer groove 5g defined to extend from adjacent the hump 5h positioned adjacent the first corner 5c to the first channel 5f and a second inner groove 5v and a second outer groove 5g defined to extend from adjacent the first channel 5f to adjacent the hump 5h positioned adjacent the second corner 5c. A first step 5k of the top 5t can be defined to extend between an inner side of the first outer groove 5g to an outer wall of the first inner groove 5v and a second step 5k of the top 5t can be defined to extend between an inner side of the second outer groove 5g to the outer wall of the second inner groove 5v.

The top 5t can also have a third inner groove 5v and a third outer groove 5g defined to extend from adjacent the hump 5h positioned adjacent the second corner 5c to the second channel 5f and a fourth inner groove 5v and a fourth outer groove 5g defined to extend from adjacent the second channel 5f to adjacent the hump 5h positioned adjacent the third corner 5c. A third step 5k of the top 5t can be defined to extend between an inner side of the third outer groove 5g to an outer wall of the third inner groove 5v and a fourth step 5k of the top 5t can be defined to extend between an inner side of the fourth outer groove 5g to the outer wall of the fourth inner groove 5v.

The top 5t can also include a fifth inner groove 5v and a fifth outer groove 5g defined to extend from adjacent the hump 5h positioned adjacent the third corner 5c to the third channel 5f and a sixth inner groove 5v and a sixth outer groove 5g defined to extend from adjacent the third channel 5f to adjacent the hump 5h positioned adjacent the fourth corner 5c. A fifth step 5k of the top 5t can be defined to extend between an inner side of the fifth outer groove 5g to an outer wall of the fifth inner groove 5v and a sixth step 5k of the top 5t can be defined to extend between an inner side of the sixth outer groove 5g to the outer wall of the sixth inner groove 5v.

The top 5t can also include a seventh inner groove 5v and a seventh outer groove 5g defined to extend from adjacent the hump 5h positioned adjacent the fourth corner 5c to the fourth channel 5f and an eighth inner groove 5v and an eighth outer groove 5g defined to extend from adjacent the fourth channel 5f to adjacent the hump 5h positioned adjacent the first corner. A seventh step 5k of the top can be defined to extend between an inner side of the seventh outer groove 5g to an outer wall of the seventh inner groove 5v and an eighth step 5k of the top can be defined to extend between an inner side of the eighth outer groove 5g to the outer wall of the eighth inner groove 5v.

The bottom 5b of the body 5 can also have a number of inner grooves 5v and outer grooves 5g. For example, the bottom 5b of the body 5 can have a first inner groove 5v and a first outer groove 5g defined to extend from adjacent the hump 5h positioned adjacent the first corner 5c to the first channel 5f and a second inner groove 5v and a second outer groove 5g defined to extend from adjacent the first channel 5f to adjacent the hump 5h positioned adjacent the second corner 5c. A first step 5k of the bottom 5b can be defined to extend between an inner side of the first outer groove 5g to an outer wall of the first inner groove 5v and a second step 5k of the bottom 5b can be defined to extend between an inner side of the second outer groove 5g to the outer wall of the second inner groove 5v.

The bottom 5b can also have a third inner groove 5v and a third outer groove 5g defined to extend from adjacent the hump 5h positioned adjacent the second corner 5c to the second channel 5f and a fourth inner groove 5v and a fourth outer groove 5g defined to extend from adjacent the second channel 5f to adjacent the hump 5h positioned adjacent the third corner 5c. A third step 5k of the bottom 5b can be defined to extend between an inner side of the third outer groove 5g to an outer wall of the third inner groove 5v and a fourth step 5k of the bottom 5b can be defined to extend between an inner side of the fourth outer groove 5g to the outer wall of the fourth inner groove 5v.

The bottom 5b can also include a fifth inner groove 5v and a fifth outer groove 5g defined to extend from adjacent the hump 5h positioned adjacent the third corner 5c to the third channel 5f and a sixth inner groove 5v and a sixth outer groove 5g defined to extend from adjacent the third channel 5f to adjacent the hump 5h positioned adjacent the fourth corner 5c. A fifth step 5k of the bottom 5b can be defined to extend between an inner side of the fifth outer groove 5g to an outer wall of the fifth inner groove 5v and a sixth step 5k of the bottom 5b can be defined to extend between an inner side of the sixth outer groove 5g to the outer wall of the sixth inner groove 5v.

The bottom 5b can also include a seventh inner groove 5v and a seventh outer groove 5g defined to extend from adjacent the hump 5h positioned adjacent the fourth corner 5c to the fourth channel 5f and an eighth inner groove 5v and an eighth outer groove 5g defined to extend from adjacent the fourth channel 5f to adjacent the hump 5h positioned adjacent the first corner. A seventh step 5k of the bottom 5b can be defined to extend between an inner side of the seventh outer groove 5g to an outer wall of the seventh inner groove 5v and an eighth step 5k of the bottom 5b can be defined to extend between an inner side of the eighth outer groove 5g to the outer wall of the eighth inner groove 5v.

The top 5t can also have tapered land 5L that extends along the first side 5 adjacent a tapered cutting edge 5e that extends along the first side 5s adjacent the top 5t, a tapered land 5L that extends along the second side 5s adjacent a tapered cutting edge 5e that extends along the second side 5s adjacent the top 5t, a tapered land 5L that extends along the third side 5s adjacent a tapered cutting edge 5e that extends along the third side 5s adjacent the top 5t, and a tapered land 5L that extends along the fourth side 5s adjacent a tapered cutting edge 5e that extends along the fourth side 5s adjacent the top 5t.

The bottom 5b can also have tapered lands 5L and tapered cutting edges 5e. For example, the bottom 5b can include a tapered land 5L that extends along the first side 5s adjacent a tapered cutting edge 5e that extends along the first side 5s adjacent the bottom, a tapered land 5L that extends along the second side 5s adjacent a tapered cutting edge 5e that extends along the second side 5s adjacent the bottom, a tapered land 5L that extends along the third side 5s adjacent a tapered cutting edge 5e that extends along the third side 5s adjacent the bottom 5b, and a tapered land 5L that extends along the fourth side 5s adjacent a tapered cutting edge 5e that extends along the fourth side 5s adjacent the bottom 5b.

Of course, in some embodiments that may only have three sides (e.g. embodiments of FIG. 8 or FIG. 9), the bottom 5b and top 5t may not include a tapered land 5L that extends along the fourth side 5s adjacent a tapered cutting edge 5e that extends along the fourth side 5s. Such embodiments may only have first, second and third sides 5s, first, second and third corners 5c, and first, second, third, fourth, fifth, and sixth inner grooves 5v and first, second, third, fourth, fifth, and sixth outer grooves 5g. Such embodiments may also only have at least one first channel 5f, at least one second channel 5f, and at least one third channel 5f.

Other body 5 configurations may have more than four sides 5s, more than four corners 5c, and also more than four humps 5h and ribs 5r as well as more channels 5f, lands 5L and cutting edges 5e. For example, a body can have a generally pentagonal or hexagonal shape that has five or six sides 5s and five or six corners 5c.

We have surprisingly found that the positioning and configuration of the humps 5h and ribs 5r can provide improved chip breaking that can help accommodate a wide range of depths of cut and material feed rates. For example, we have surprisingly found that the humps 5h adjacent the corners 5h that are reinforced by an adjacent rib can provide improved chip breaking at relatively low feed rates for a large range of depth of cuts. The humps 5h and ribs 5r can also facilitate effective chip breaking at high feed rates for a large range of depth of cuts as well. The advantages of such improved chip breaking can be further enhanced by utilization of the inner and outer grooves 5v and 5g, which can facilitate effective chip breaking at low and high feed rates and low and high depth of cut settings.

We have also found that the tapered cutting edges 5e and lands 5L for the top and bottom of the sides 5s can facilitate the lands 5L breaking chips at low and high feed rates for a large range of depth of cuts while also adding strength to the cutting edges 5e.

Embodiments of the cutting inserts 4 can be utilized in cutting operations for a wide range of feed rates and depths of cut, which can provide enhanced operational flexibility and efficiency. For example, tool changing can be needed less frequently during operations. Also, embodiments may wear more uniformly such that they may have a longer life as well. Some embodiments can permit a versatile array of features for use in many different types of cutting operations in which the cutting insert is held stationary or moved linearly along a rotating workpiece to cut the workpiece to provide enhanced operational flexibility and efficiency

For example, a method of cutting a workpiece can include attaching a cutting insert 4 to a holder 3 for having the cutting insert engage a workpiece to cut the workpiece. In some embodiments, the holder 3 can be a holder of a cutting machine, CNC machine, or other type of device configured to cut a workpiece to form a component or a part.

The workpiece can be rotated while the cutting insert 4 contacts the workpiece to cut the workpiece. In some embodiments, the cutting insert 4 can be affixed to a holder 3 as the holder 3 is linearly moved along a rotating workpiece, for example. As the workpiece is cut via contact with at least one cutting edge 5e of the cutting insert 4, chips can be broken off via the chip breaking mechanism 6. In some embodiments, such chip breaking can be facilitated via at least one of the humps 5h, at least one of the hump feeding ramped surfaces 5w, at least one of the ribs 5r, at least one of the inner grooves 5v, at least one of the outer grooves 5g, and at least one of the channels 5f as well as at least one of the lands 5L and at least one of the cutting edges 5e.

Embodiments of such a method can be performed such that the cutting of workpieces can be performed more efficiently and effectively for a large range of cutting or finishing applications that may include a large range of depths of cuts and a large range of feed rates.

It should be appreciated that the exemplary embodiments discussed herein can be adjusted to account for a particular set of design criteria. For example, the size and shape of the body of cutting insert 4, the size and shape of channels 5f, generally elliptical humps 5h, ribs 5r, inner and outer grooves 5v and 5g, and the type of materials utilized for the body 5 of the cutting insert 4 can be any of a number of different options. For instance, the type of material used for the body 5 of the cutting insert 4 can be carbide, cemented carbine, tungsten carbide, ceramic material, steel, tool steel, etc. As yet another example, the moveable member 5 can be a linearly moveable shaft, rod, bar, or rail for movement of the cutting insert 4 while it is affixed to a holder 3 in a non-moving manner (e.g. the cutting insert does not rotate while the holder moves the cutting inserts linearly along a workpiece). Thus, while certain present preferred embodiments of the cutting apparatus, cutting insert, and embodiments of methods for making and using the same have been shown and described above, it is to be distinctly understood that the invention is not limited thereto but may be otherwise variously embodied and practiced within the scope of the following claims.

What is claimed is:

1. A cutting insert for a cutting apparatus comprising:
a body having a top and a bottom,
the body have a plurality of sides and a plurality of corners, each of the sides extending from the top to the bottom and each of the corners extending from the top to the bottom, the sides including a first side, a second side, and a third side and the corners including a first corner, a second corner, and a third corner, the first corner being between the first side and the second side, the second corner being between the second side and the third side, and the third corner being adjacent the third side;
the top of the body having a hump positioned adjacent the first corner and a rib positioned adjacent the first corner such that the hump positioned adjacent the first corner is positioned between an outer edge of the first corner and the rib positioned adjacent the first corner.

2. The cutting insert of claim 1, wherein the sides include a fourth side and the corners include a fourth corner, the third corner being between the third side and the fourth side and the fourth corner being between the fourth side and the first side.

3. The cutting insert of claim 1, wherein the top of the body also has:
a hump positioned adjacent the second corner and a rib positioned adjacent the second corner such that the hump positioned adjacent the second corner is positioned between an outer edge of the second corner and the rib positioned adjacent the second corner;
a hump positioned adjacent the third corner and a rib positioned adjacent the third corner such that the hump positioned adjacent the third corner is positioned between an outer edge of the third corner and the rib positioned adjacent the third corner; and
a hump positioned adjacent the fourth corner and a rib positioned adjacent the fourth corner such that the hump positioned adjacent the fourth corner is positioned between an outer edge of the fourth corner and the rib positioned adjacent the fourth corner.

4. The cutting insert of claim 3, wherein the bottom of the body has:
a hump positioned adjacent the first corner and a rib positioned adjacent the first corner such that the hump positioned adjacent the first corner is positioned between an outer edge of the first corner and the rib positioned adjacent the first corner;
a hump positioned adjacent the second corner and a rib positioned adjacent the second corner such that the hump positioned adjacent the second corner is positioned between an outer edge of the second corner and the rib positioned adjacent the second corner;
a hump positioned adjacent the third corner and a rib positioned adjacent the third corner such that the hump positioned adjacent the third corner is positioned between an outer edge of the third corner and the rib positioned adjacent the third corner; and
a hump positioned adjacent the fourth corner and a rib positioned adjacent the fourth corner such that the hump positioned adjacent the fourth corner is positioned between an outer edge of the fourth corner and the rib positioned adjacent the fourth corner.

5. The cutting insert of claim 3, wherein the top also has:
an inner groove and an outer groove defined adjacent each of the sides, the inner groove having a different radius than the outer groove.

6. The cutting insert of claim 3, wherein the top also has:
a first channel defined adjacent a middle region of the first side;
a second channel defined adjacent a middle region of the second side;
a third channel defined adjacent a middle region of the third side; and
a fourth channel defined adjacent a middle region of the fourth side.

7. The cutting insert of claim 6, wherein the top also has:
a first inner groove and a first outer groove defined to extend from adjacent the hump positioned adjacent the first corner to the first channel and a second inner groove and a second outer groove defined to extend from adjacent the first channel to adjacent the hump positioned adjacent the second corner;
a third inner groove and a third outer groove defined to extend from adjacent the hump positioned adjacent the second corner to the second channel and a fourth inner groove and a fourth outer groove defined to extend from adjacent the second channel to adjacent the hump positioned adjacent the third corner;
a fifth inner groove and a fifth outer groove defined to extend from adjacent the hump positioned adjacent the third corner to the third channel and a sixth inner groove and a sixth outer groove defined to extend from adjacent the third channel to adjacent the hump positioned adjacent the fourth corner; and
a seventh inner groove and a seventh outer groove defined to extend from adjacent the hump positioned adjacent the fourth corner to the fourth channel and an eighth inner groove and an eighth outer groove defined to extend from adjacent the fourth channel to adjacent the hump positioned adjacent the first corner.

8. The cutting insert of claim 7, wherein the top also has a tapered land that extends along the first side adjacent a tapered cutting edge that extends along the first side adjacent the top, a tapered land that extends along the second side adjacent a tapered cutting edge that extends along the second side adjacent the top, a tapered land that extends along the third side adjacent a tapered cutting edge that extends along the third side adjacent the top, and a tapered land that extends along the fourth side adjacent a tapered cutting edge that extends along the fourth side adjacent the top.

9. The cutting insert of claim 8, wherein the bottom of the body has:
a hump positioned adjacent the first corner and a rib positioned adjacent the first corner such that the hump positioned adjacent the first corner is positioned between an outer edge of the first corner and the rib positioned adjacent the first corner;
a hump positioned adjacent the second corner and a rib positioned adjacent the second corner such that the hump positioned adjacent the second corner is positioned between an outer edge of the second corner and the rib positioned adjacent the second corner;
a hump positioned adjacent the third corner and a rib positioned adjacent the third corner such that the hump positioned adjacent the third corner is positioned between an outer edge of the third corner and the rib positioned adjacent the third corner; and
a hump positioned adjacent the fourth corner and a rib positioned adjacent the fourth corner such that the hump positioned adjacent the fourth corner is positioned between an outer edge of the fourth corner and the rib positioned adjacent the fourth corner;
a first channel defined adjacent a middle region of the first side;
a second channel defined adjacent a middle region of the second side;
a third channel defined adjacent a middle region of the third side; and
a fourth channel defined adjacent a middle region of the fourth side.

10. The cutting insert of claim 9, wherein the bottom of the body has:
a first inner groove and a first outer groove defined to extend from adjacent the hump positioned adjacent the first corner to the first channel and a second inner groove and a second outer groove defined to extend from adjacent the first channel to adjacent the hump positioned adjacent the second corner;
a third inner groove and a third outer groove defined to extend from adjacent the hump positioned adjacent the second corner to the second channel and a fourth inner groove and a fourth outer groove defined to extend from adjacent the second channel to adjacent the hump positioned adjacent the third corner;
a fifth inner groove and a fifth outer groove defined to extend from adjacent the hump positioned adjacent the third corner to the third channel and a sixth inner groove and a sixth outer groove defined to extend from adjacent the third channel to adjacent the hump positioned adjacent the fourth corner; and
a seventh inner groove and a seventh outer groove defined to extend from adjacent the hump positioned adjacent the fourth corner to the fourth channel and an eighth inner groove and an eighth outer groove defined to extend from adjacent the fourth channel to adjacent the hump positioned adjacent the first corner.

11. The cutting insert of claim 10, wherein the bottom also has:
a tapered land that extends along the first side adjacent a tapered cutting edge that extends along the first side adjacent the bottom, a tapered land that extends along the second side adjacent a tapered cutting edge that extends along the second side adjacent the bottom, a tapered land that extends along the third side adjacent a tapered cutting edge that extends along the third side adjacent the bottom, and a tapered land that extends along the fourth side adjacent a tapered cutting edge that extends along the fourth side adjacent the bottom.

12. The cutting insert of claim 1, wherein the third corner is between the third side and the first side and wherein the top of the body also has:
a hump positioned adjacent the second corner and a rib positioned adjacent the second corner such that the hump positioned adjacent the second corner is positioned between an outer edge of the second corner and the rib positioned adjacent the second corner; and
a hump positioned adjacent the third corner and a rib positioned adjacent the third corner such that the hump positioned adjacent the third corner is positioned between an outer edge of the third corner and the rib positioned adjacent the third corner.

13. The cutting insert of claim 1, wherein the body has a central aperture and the top has at least one seating surface defined adjacent a mouth that is in communication with the central aperture.

14. The cutting insert of claim 13, wherein the bottom has at least one seating surface defined adjacent a mouth that is in communication with the central aperture.

15. The cutting insert of claim 1, wherein the body is rectangular in shape or rhombus in shape.

16. A cutting apparatus comprising:
a member having a holder;
a cutting insert attached to the holder, the cutting insert including:
a body having a top and a bottom,
the body having a plurality of sides and a plurality of corners, each of the sides extending from the top to the bottom and each of the corners extending from the top to the bottom, the sides including a first side, a second side, and a third side and the corners including a first corner, a second corner, and a third corner, the first corner being between the first side and the second side, the second corner being between the second side and the third side, and the third corner being adjacent the third side;
the top of the body having a hump positioned adjacent the first corner and a rib positioned adjacent the first corner such that the hump positioned adjacent the first corner is positioned between an outer edge of the first corner and the rib positioned adjacent the first corner.

17. The cutting apparatus of claim 16, wherein the sides of the body of the cutting insert includes a fourth side and the corners of the body of the cutting insert includes a fourth corner, the third corner being between the third side and the fourth side and the fourth corner being between the fourth side and the first side; and
wherein the top of the body also has:
a hump positioned adjacent the second corner and a rib positioned adjacent the second corner such that the hump positioned adjacent the second corner is positioned between an outer edge of the second corner and the rib positioned adjacent the second corner;
a hump positioned adjacent the third corner and a rib positioned adjacent the third corner such that the hump positioned adjacent the third corner is positioned between an outer edge of the third corner and the rib positioned adjacent the third corner; and
a hump positioned adjacent the fourth corner and a rib positioned adjacent the fourth corner such that the hump positioned adjacent the fourth corner is positioned between an outer edge of the fourth corner and the rib positioned adjacent the fourth corner.

18. The cutting apparatus of claim 17, wherein the top of the body of the cutting insert also has:
a first channel defined adjacent a middle region of the first side;
a second channel defined adjacent a middle region of the second side;
a third channel defined adjacent a middle region of the third side; and
a fourth channel defined adjacent a middle region of the fourth side.

19. The cutting apparatus of claim 18, wherein the top of the body of the cutting insert also has:
a first inner groove and a first outer groove defined to extend from adjacent the hump positioned adjacent the first corner to the first channel and a second inner groove and a second outer groove defined to extend from adjacent the first channel to adjacent the hump positioned adjacent the second corner;
a third inner groove and a third outer groove defined to extend from adjacent the hump positioned adjacent the second corner to the second channel and a fourth inner groove and a fourth outer groove defined to extend from adjacent the second channel to adjacent the hump positioned adjacent the third corner;
a fifth inner groove and a fifth outer groove defined to extend from adjacent the hump positioned adjacent the third corner to the third channel and a sixth inner groove and a sixth outer groove defined to extend from adjacent the third channel to adjacent the hump positioned adjacent the fourth corner; and
a seventh inner groove and a seventh outer groove defined to extend from adjacent the hump positioned adjacent the fourth corner to the fourth channel and an eighth inner groove and an eighth outer groove defined to extend from adjacent the fourth channel to adjacent the hump positioned adjacent the first corner.

20. The cutting apparatus of claim 19, wherein the top of the body of the cutting insert also has:
a tapered land that extends along the first side and a tapered cutting edge that extends along the first side adjacent the top, a tapered land that extends along the second side and a tapered cutting edge that extends along the second side adjacent the top, a tapered land that extends along the third side and a tapered cutting edge that extends along the third side adjacent the top, and a tapered land that extends along the fourth side and a tapered cutting edge that extends along the fourth side adjacent the top.
